(19) United States
(12) Patent Application Publication
(10) Pub. No.: US 2023/0047730 A1
(43) Pub. Date: Feb. 16, 2023

(54) Sinterable Compounds Comprising Dielectric Material, Articles Formed from Such Compounds, and Methods of Forming Such Compounds and Articles

(71) Applicant: Science Applications International Corporation, Reston, VA (US)

(72) Inventors: John P. Timler, River Ridge, LA (US); Xingcun C. Tong, Bolingbrook, IL (US)

(21) Appl. No.: 17/402,324

(22) Filed: Aug. 13, 2021

(51) Int. Cl. C04B 35/515; C04B 35/64; C04B 35/634; C04B 35/63

(52) U.S. Cl. CPC C04B 35/515; C04B 35/64; C04B 35/63488; C04B 35/6303; C04B 2235/5418

(57) ABSTRACT

A sinterable compound may comprise one or more Ga-alkali metal alloys (and/or one or more Hg-alkali metal amalgams) and one or more filler materials (e.g., one or more dielectric materials). To form a dielectric article or other article, the compound may be formed into a desired shape. Raising the temperature of the compound initiates an exothermic reaction of alkali metal and water and causes the filler materials to self-sinter.

### GOVERNMENT LICENSE RIGHTS

This invention was made with Government support under Contract No. N00178-04-D-4119-FC46 awarded by the United States Navy. The Government has certain rights in this invention.

### BACKGROUND

Dielectric materials are used in electronic components and in various other applications. Desirable properties of dielectric materials may include high capacitance and high break down insulation. Dielectric materials may include inorganic or ceramic-based dielectrics such as metal oxides (MOs), nitrides (e.g., silicon nitride (Si₃N₄), aluminum nitride (AlN)), perovskites, hybrids, etc. Other dielectric materials (e.g., for flexible electronics applications) may include polymer composites comprising nanofillers, high-K dielectric materials, and liquid ion gels. Some of the high-K nanomaterials used to develop hybrid dielectric materials include titanium dioxide (TiO₂) and barium titanate (BaTiO₃). In addition to other high-K dielectric composites, high-K materials such as aluminum oxide (Al₂O₃), tantalum oxide (Ta₂O₅), and silicon dioxide (SiO₂) have also been used as gate dielectrics.

Sintering is a process that may be used to form dielectrics, and that may include firing a green body at high temperatures. Microwave dielectric ceramics, used in co-fired waveguide circuits, may include high-temperature co-fired ceramics (HTCCs) formed by sintering at temperatures above 1000° C., low-temperature co-fired ceramics (LTCCs) formed by sintering at temperatures from 700° C. to 1000° C., and ultralow-temperature co-fired ceramics (ULTCCs) formed by sintering at temperatures from 400° C. to 700° C. HTCCs include complex perovskites, barium titanates, niobates, or silicates, which cannot be co-fired with base-metal or low melting temperature electrodes (e.g., silver (Ag), copper (Cu), aluminum (Al)) and whose manufacturing process steps are energy intensive. LTCCs and ULTCCs, which may be co-fired with base-metal electrodes without melting and interaction, include glass-ceramics, tellurates, molybdates, vanadates, tungstates and borates. The sintering temperatures of LTCCs and ULTCCs are still much higher than can be withstood by a polymer-based printed circuit boards (PCBs). Cold-sintered co-fired ceramics (CSCCs) may include ceramics or ceramic composites that can be densified at comparatively low temperatures below 200° C. by cold sintering processes, but those processes are based on extreme pressures.

Gas-phase deposition (chemical vapor deposition (CVD), atomic layer deposition (ALD), sputtering, pulsed laser deposition (PLD), and E-beam evaporation) and solution processes have been used to grow inorganic dielectric thin films or substrates. Although gas-phase deposition methods may produce high-quality inorganic films, those methods are time-consuming and capital-intensive. Inorganic dielectric films processed from solution precursors have been investigated using different coating and printing methodologies such as spin-coating, spray coating, inkjet printing, and gravure printing. However, these processes still suffer from the requirement of post film deposition sintering/annealing at high temperatures (typically above 400° C.) to enable film densification and impurity removal.

Other processes also have disadvantages. Ultra Low Energy Sintering (ULES) allows reduced sintering temperatures, but still relies on high pressures (e.g., pressure between 150 megapascals (MPa) and 300 MPa may be needed if sintering temperatures are below 300° C.). Other disadvantages of ULES may include a need for pretreatment to increase solubility of ceramic or other dielectric fillers in a hydrothermal aqueous solution, formation of amorphous phase at grain boundaries that decreases the performance of ceramics/dielectrics and that may require a post-annealing process to eliminate, challenges in proper selection of the processing parameters (such as applied pressure, temperature, ramp rate, and sintering duration), difficulties in scaling, and difficulties achieving uniform distribution of pressure and temperature as component dimensions increase. Flash sintering may allow low temperatures, but requires the presence of a strong electric field (e.g., at least 1000 Volts/centimeter).

### SUMMARY

This Summary is provided to introduce a selection of some concepts in a simplified form as a prelude to the Detailed Description. This Summary is not intended to identify key or essential features.

A sinterable compound comprising one or more gallium (Ga)-alkali metal alloys and/or one or more mercury (Hg)-alkali metal amalgams, as well as one or more filler materials, may be prepared. The filler materials may comprise one or more dielectric materials and/or one or bonding additives, as well as a gel to suspend and/or support other components of the compound and to retain water. The filler materials may be selected based on dielectric and/or other properties. The compound may be stable when kept at a temperature below a eutectic reaction temperature of the one or more Ga-alkali metal alloys and/or the one or more Hg-alkali metal amalgams. Prior to curing, the compound may be molded, printed, patterned, and/or otherwise formed into any arbitrary shape. After forming, the compound may be cured by raising the temperature above a eutectic reaction temperature of the one or more Ga-alkali alloys and/or the one or more Hg-alkali metal amalgams. Raising the temperature of the compound above that eutectic reaction temperature initiates an exothermic reaction between alkali metal from the one or more Ga-alkali metal alloys (and/or the one or more Hg-alkali metal amalgams) and water from the gel. The reaction may continue and may cause the filler materials to self-sinter. Because the eutectic reaction temperature may be relatively low (e.g., in a room temperature range), the sintering may occur at relatively low temperatures and without requiring external pressure or other energy input.

These and other features are described in more detail below.

### BRIEF DESCRIPTION OF THE DRAWINGS

Some features are shown by way of example, and not by way of limitation, in the figures of the accompanying drawings and in which like reference numerals refer to similar elements.

FIG. 1 is a flow chart showing steps of an example process for fabricating a sinterable dielectric compound and one or more articles formed from such a compound.

FIG. 2 shows an example of prefabricated and prepackaged parts of a sinterable dielectric compound.

FIGS. 3A, 3B, and 3C show examples of forming an uncured sinterable dielectric compound into a shape.

FIGS. 4A, 4B, and 4C are diagrams showing, at a particle level, example structures during forming of a sinterable dielectric compound and after curing.

### DETAILED DESCRIPTION

Sinterable compounds, methods of forming sinterable compounds, methods of forming articles using sinterable compounds, and formed articles are described herein. The sinterable compounds, and articles formed form such compounds, may comprise one or more dielectric materials. Methods of forming articles may comprise sintering of materials (e.g., one or more dielectric materials) at low temperatures (e.g., temperatures less than 100° C.) and/or low pressures (pressure of 1 MPa or less). Also or alternatively, such methods may be performed without any external heating (beyond energy transfer associated with ambient room temperatures) or other forms of energetic input (e.g., microwave, laser, sonic, pressure, electric field, spark plasma, chemical vapor deposition (CVD), physical vapor deposition (PVD), sputtering, etc.). Compounds and/or methods described herein may be used to fabricate articles with arbitrary geometries and properties that are tailored based on one or more constituents of a sinterable compound. Properties that may be tailored may comprise insulation, capacitance, thermal conductivity, thermal expansion, ferromagnetic and/or ferroelectronic functions, piezoelectric and/or thermoelectric effects, high frequency response parameters, and/or other properties.

An uncured (e.g., wet or green) sinterable compound may be formed into a desired shape. The forming may comprise molding, printing, and/or other patterning (e.g., using one or more additive manufacturing methods). After forming, the uncured sinterable compound may be cured by raising its temperature to a eutectic reaction temperature of a gallium-alkali metal (Ga-alkali metal) alloy component of the uncured compound. Raising the uncured compound to that temperature may cause alkali metal from that Ga-alkali metal alloy to react with water released from a water-absorbing gel component of the uncured compound. An exothermic reaction between the water and one or more alkali elements of the Ga-alkali metal alloy component may create an intense and highly localized heating effect. This heating effect may cause self-sintering and promote chemical adhesion between other components (e.g., one or more dielectric filler materials, one or more bonding agents) of the compound. After cooling, a solid/densified material remains. Further densification may occur, after completion of the water and alkali metal reaction, through Ga diffusion and intermetallic oxidation reactions in grain boundaries and voids. This diffusion and these oxidation reactions may reduce porosity and enhance adhesion/bonding between dielectric fillers without a significant temperature or pressure excursion and/or without other energetic input.

Compounds and/or methods described herein may, for example, be useful for products and/or technologies that cannot endure extreme temperatures during manufacture, but which require dielectric films (and/or other dielectric elements) with insulating or capacitance properties equivalent to ceramics made at high temperatures and/or pressures. Dielectric multi-functional material parameters (e.g., thermal conductivity, ferromagnetic and/or ferromagnetic properties, piezoelectric and/or thermoelectric properties, high frequency response performance properties, etc.) may be selected and/or optimized by selecting components of a sinterable compound. Examples of applications in which compounds and/or methods described herein may be used comprise printed circuit boards (PCBs), flexible and/or wearable electronics, bioelectronics (e.g., implants), batteries, capacitors, heat spreaders, hypersonic vehicle fuselage elements, heat shields, filters, resonators, antennas, ferroelectric memory, thermoelectric generators, medical transducers, microwave circuits and mm-wave wireless communication systems, 2.5/3D electronic systems-on-a-chip, multi-step electronics packaging (e.g., where high temperature, high pressure or high energy processes would destroy precursor assembly steps), and/or hybrid chemical and/or electronic systems.

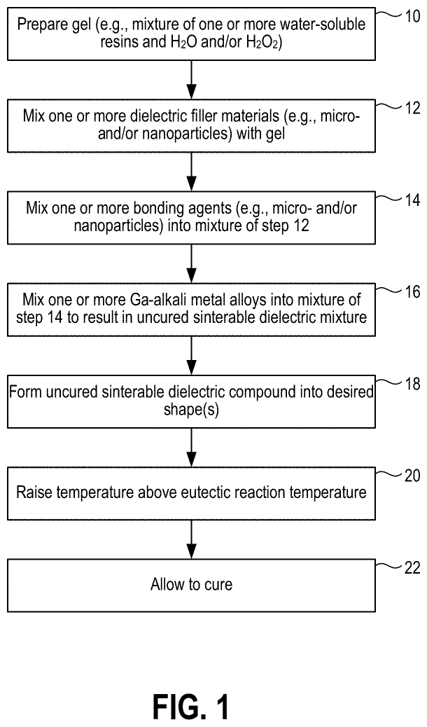

FIG. 1 is a flow chart showing steps of an example process for preparing a sinterable dielectric compound and forming one or more articles from such a compound. One or more steps of the method may be omitted, performed in an order other than shown in FIG. 1, and/or otherwise modified. One or more steps may be combined. One or more other steps may be added.

In a first step 10, preparation of a sinterable dielectric compound may begin with preparation of a gel. The gel may function as a binder and/or suspending agent for other components of the sinterable dielectric compound. The gel may bind/suspend those components during storage, during forming of the sinterable dielectric compound into a shape, and/or during at least a portion of self-sintering that may occur after the sinterable dielectric compound is brought to an activation temperature. As explained in more detail below, the bound/suspended components may comprise one or more dielectric filler materials, one or more bonding agents, and/or one or more Ga-alkali metal alloys. The gel may also provide water for exothermic reaction with one or more alkali metals (released from the one or more Ga-alkali metal alloy components) during self-sintering.

The gel may, for example, be prepared by mixing of one or more water-soluble resins with water and/or hydrogen peroxide (H₂O₂). The one or more water-soluble resins may comprise nonionic polymers such as a nonionic poly(ethylene oxide) polymer. Such a resin may, for example, comprise a resin having a general composition of 95% by weight (wt %) to 100 wt % poly(ethylene oxide), up to 3 wt % fumed silica, and up to 1 wt % calcium (e.g., as mixed salts). Examples of such resins are commercially available from DowDuPont under the trade names POLYOX™WSR N750 and POLYOX™WSR 301.

The gel may comprise between 1 wt % to 30 wt % of the one or more water-soluble resins, which may take form of a powder prior to mixing with water and/or H₂O₂. The ratio between the water (and/or H₂O₂) and water-soluble resin in the gel, and the concentration of the gel in the self-sintering compound, may be tuned and/or otherwise manipulated so that an exothermic reaction in the sinterable compound may provide high enough temperature for self-sintering. Forming the gel to provide sufficiently high temperatures may help control and/or minimize the formation of oxides, metal oxyhydrides, and/or molecular hydrogen (H₂) bubbles during self-sintering, and may help reduce volume of voids and/or a quantity of unused reactants that remain after the self-sintering.

The gel may comprise other components. For example, one or more other water-soluble materials (e.g., one or more phosphorus oxoacid compounds, one or more halogen compounds, one or more gelatins, polyvinyl alcohol, polyvinyl acetal, polyvinylpyrrolidone, carrageenan, carboxylmethyl cellulose, hydroxylpropyl cellulose, and/or other additives) may be mixed into the gel to increase stability, control viscosity, etc. Also or alternatively, additives such as potassium hydroxide (KOH), potassium chloride (KCl), sodium chloride (NaCl), hydrochloric acid (HCl), barium chloride (BaCl₂), bismuth oxychloride (BiOCl), sodium borohydride (NaBH₄), sodium magnesium hydride (NaMgH₃), and/or aluminum hydroxide (Al(OH)₃) may be mixed into the gel to enhance the exothermic reaction (e.g., by changing the reaction strength and/or temperature) and/or to promote the self-sintering at relatively low temperatures.

Also or alternatively, one or more other polymeric binders (e.g., one or more acrylic compounds, silicone, styrene, one or more fluoroelastomers, one or more urethane backbones, etc.), may also be added to the gel help in homogeneous dispersion of filler(s) and/or of the Ga-alkali alloy(s) into the sinterable compound, to hold the components of the sinterable compound together upon solvent evaporation, and/or to help bind the sinterable compound onto a substrate. In addition to water and/or hydrogen peroxide, other paste/ink solvents may be added to provide enhanced solubility to the water-soluble polymer or other polymeric binder and/or to impart favorable viscosity, surface tension, and homogeneity. Other additives may be also included to further impart desired rheological, wetting, healing, or stretching properties to the sinterable compound. Additives in the form of surfactants, adhesion improvers, humectants, penetration promoters, and/or stabilizers are may be included to tailor the sinterable compound properties for specific applications.

In step 12, preparation of the sinterable dielectric compound may continue by mixing one or more dielectric filler materials with the gel prepared in step 10. The one or more dielectric filler materials may comprise particles of one or more materials that may be selected and/or combined to obtain desired properties in a dielectric article formed from a sinterable dielectric compound that comprises those selected filler materials. Those properties may, for example, comprise dielectric properties, insulation properties, electrical properties, thermal properties, capacitance, thermal conductivity, ferromagnetic and/or ferroelectronic properties, piezoelectric and/or thermoelectric properties, high frequency response properties, and/or other properties. Dielectric filler materials may also be selected based on additional desired properties (e.g., flexibility, conformability by metallic bonder and/or liquid metal fusion). Dielectric material particles may be activated or otherwise treated to increase adhesion and/or other bonding characteristics. An example of a dielectric filler material particle with a treated surface may comprise a particle of hydrophobic fumed silica.

A particle need not have a particular shape. For example, a particle may comprise a sphere, a regular or irregular polygon, a wire, a strand, a whisker, and/or any other shape. Dielectric filler material particles may be micro- or nano-sized. A size of a particle may correspond to a largest linear dimension of a particle (e.g., a diameter of a sphere, a length of a whisker, a long internal diameter of a cube, etc.). Micro-particles may, for example, have sizes from 1 micrometer (μm) to 2000 μm. Nanoparticles may, for example, have sizes from 1 nanometer (nm) to 100 nm (i.e., from 0.001 μm to 0.1 μm). Particle sizes of dielectric filler material particles may, for example, range from 20 nm to 2000 μm. Minimum particle size may be as low as 4 nanometers or even lower, but at least 20 nm may be more common for commercial applications. Particle size between 100 nm and 100 μm may be preferred in at least some applications because of combined considerations of material processing cost, performance, and operation. As to material processing costs, higher cost may be associated with obtaining smaller particle sizes. With regard to performance, larger particle sizes for a given dielectric material may result in an article that has better properties relative to an article formed from smaller particles of the same dielectric material. Operationally, however, smaller particles may offer an advantage during mixing of materials (to prepare a sinterable dielectric compound) and/or during self-sintering, although particles having extremely small sizes (e.g., 4 nm or less) may present additional handling difficulties.

The one or more dielectric filler materials added in step 12 may comprise particles of one or more inorganic or ceramic-based dielectrics selected, e.g., for forming an insulator and/or a capacitor. Example of such dielectric filler materials may comprise silica, alumina, metal oxides (MOs), nitrides (e.g., Si₃N₄, AlN), perovskites (e.g., calcium titanium oxide (CaTiO₃) or a material having a crystal structure similar to that of CaTiO₃), and/or hybrids of (and/or comprising) such materials. Metal elements of these inorganic or ceramic-based dielectrics may comprise group IIA elements (beryllium (Be), magnesium (Mg), calcium (Ca), strontium (Sr), barium (Ba), and/or radium (Ra)), group IIIA elements (boron (B), aluminum (Al), gallium (Ga), indium (In), and/or thallium (TI)), group IIIB elements (scandium (Sc), yttrium (Y), and/or lutetium (Lu)), group IVB elements (titanium (Ti), zirconium (Zr), and hafnium (Hf)), and/or group VB elements (vanadium (V), niobium (Nb), and tantalum (Ta)).

Also or alternatively, the one or more dielectric filler materials added in step 12 may comprise particles of one or more highly thermally conductive dielectrics. Examples of such of dielectric filler materials having high thermal conductivities may comprise AlN, Al₂O₃, beryllium oxide (BeO), silicon carbide (SiC), Si, diamond, and/or hybrids of (and/or comprising) such materials. An example hybrid is a SiC/diamond hybrid.

Also or alternatively, the one or more dielectric filler materials added in step 12 may comprise particles of one or more ferrites. A ferrite may comprise iron(III) oxide (Fe₂O₃) blended with small proportions of one or more additional metallic elements (e.g., Sr, Ba, manganese (Mn), nickel (Ni), and/or zinc (Zi)). Examples of ferrites comprise manganese-zinc ferrite (MnₐZn₍₁₋ₐ₎Fe₂O₄), nickel-zinc ferrite (NiₐZn₍₁₋ₐ₎Fe₂O₄), cobalt ferrite (CoFe₂O₄ (CoO.Fe₂O₃)), strontium ferrite (SrFe₁₂O₁₉ (SrO.6Fe₂O₃)), and barium ferrite (BaFe₁₂O₁₉ (BaO.6Fe₂O₃)).

Also or alternatively, the one or more dielectric filler materials added in step 12 may comprise particles of one or more piezoelectric ceramics. Examples of piezoelectric ceramic filler materials may comprise lead zirconate titanate (PZT), BaTiO₃, lead titanate (PbTiO₃), gallium nitride (GaN), and zinc oxide (ZnO).

Also or alternatively, the one or more dielectric filler materials added in step 12 may comprise particles of one or more thermoelectric ceramics. Examples of thermoelectric ceramic filler materials may comprise bismuth chalcogenides (e.g., bismuth telluride (Bi₂Te₃), bismuth selenide (Bi₂Se₃)), lead telluride/selenium alloys (e.g., PbTe₍₁₋ₓ₎Seₓ), inorganic clathrates (e.g., Ba₈Ga₁₆Ge₃₀), compounds of Mg and a group-14 element (e.g., magnesium silicide (Mg₂Si), magnesium germinide (Mg₂Ge), magnesium stannide (Mg₂Sn)), skutterudite thermoelectrics (e.g., LM₄X₁₂, where L is a rare-earth metal (optional component), M is a transition metal, and X is a metalloid, a group V element or a pnictogen such as phosphorus (P), antimony (Sb), or arsenic (As)), homologous oxide compounds (e.g., of the form (SrTiO₃)ₙ(SrO)ₘ), and Half-Heusler (HH) alloys (e.g., an alloy of Nb, iron (Fe), and Sb (NbFeSb), an alloy of Nb, Co, and tin (Sn) (NbCoSn), an alloy of vanadium (V), Fe, and Sb (VFeSb)).

Also or alternatively, the one or more dielectric filler materials added in step 12 may comprise particles of one or more microwave and/or millimeter-wave dielectric ceramics. Examples of such ceramic filler materials may comprise perovskites, barium titanates, niobates, silicates, glass, tellurates, molybdates, vanadates, tungstates and borates. Additional examples comprise zinc aluminate (ZnAl₂O₄), silver(I) molybdate (Ag₂MoO₄), a lithium zinc phosphate (LiZnPO₄), Eu₂Zr₃(MoO₄)₉, and La₂Zr₃(MoO₄)₉.

Also or alternatively, the one or more dielectric filler materials added in step 12 may comprise particles of one or more optical materials. Examples of such optical materials may comprise III-V compound semiconductors (e.g., alloys comprising elements from groups III (B, Al, Ga, In) and V (nitrogen (N), P, As, Sb)), superlattice semimetal materials (e.g., mercury telluride/cadmium telluride (HgTe/CdTe), a silicon germanium alloy (SiₓGe₍₁₋ₓ₎), silicon, silicon-on-silica, silicon-on-sapphire, silicon-on-nitride, glass (silica, SiON), gallium arsenide (GaAs), indium arsenide (InAs), quantum dots, and optical polymers.

In step 14, preparation of the sinterable dielectric compound may continue by mixing one or more bonding agents with the mixture from step 12 (e.g., the gel prepared in step 10 mixed with the one or more dielectric filler materials added in step 12). Although a bonding agent may be omitted, adding particles of one or more bonding agents may enhance bonding of dielectric material particles during sintering. The bonding agent(s) may comprise particles of one or more materials that enhance adhesion and bonding performance between dielectric filler material particles. The bonding agent particles may have sizes in the same or similar range as particles of the dielectric filler material(s). For example, sizes of bonding agent particles may range from 20 nm to 2000 μm, with particle size between 100 nm and 100 μm preferred in at least some applications, and with minimum particle size as low as 4 nanometers or even lower. Examples of bonding agents may comprise metals (and/or alloys), metallic compounds, metal oxides, other types of bonding additives, and/or solid/liquid hybrids comprising one or more metals, metallic compounds, metal oxides, other types of bonding agents. Additional examples of bonding agents may comprise Ag, Ag alloys, gold (Au), Au alloys, copper (Cu), Cu alloys, Zn, Zn alloys, Ni, and/or Ni alloys.

In step 16, preparation of the sinterable dielectric compound may continue by mixing one or more Ga-alkali metal alloys with the mixture from step 14 (e.g., the gel prepared in step 10 mixed with the one or more dielectric filler materials added in step 12 and with the one or more bonding additive materials added in step 14). During the mixing of step 16, the one or more Ga-alkali metal alloys and the mixture from step 14 may be maintained below a eutectic reaction temperature of the one or more Ga-alkali metal alloys. The sinterable dielectric compound formed during the mixing of step 16 may be maintained below that eutectic reaction temperature until needed.

In particular, the one or more Ga-alkali metal alloys may have low melting points. If the one or more Ga-alkali metal alloys are kept below a eutectic reaction temperature, those alloys will not react with other components of the sinterable dielectric compound. If the one or more Ga-alkali metal alloys reach the eutectic reaction temperate, however, alkali metal element(s) of the alloy(s) may be released in non-oxidized form. The released alkali metal(s) cause an exothermic reaction based on contact with water in the sinterable dielectric compound, and thereby trigger a self-sintering reaction that bonds the dielectric material particles. The Ga-based alloy(s) are also be helpful to improve adhesion performance and/or bonding strength between a substrate and a structure formed from a sinterable dielectric compound placed on that substrate.

The eutectic reaction temperature of the one or more Ga-alkali metal alloys of the sinterable dielectric compound will depend on the alloy, or combination of alloys, present. In general, however, that temperature may tunable (by selecting alloys and/or combinations of alloys) to a desired temperature between −15° C. and 300° C. For at least some applications, that temperature is tuned to a temperature between 30° C. and 100° C. (e.g., 26.8° C.±5%). The one or more Ga-Alkali metal alloys may comprise one or more alloys that comprise, consist essentially of, or consist of 99 wt % to 50 wt % of Ga, with the remainder being an alkali metal and, optionally, one or more additional elements. Examples of such Ga-alkali metal alloys comprise Ga—Al alloys, Ga—AlTiC alloys (e.g., alloys of Ga and a master alloy comprising Al, titanium (Ti) and carbon (C)), Ga—Al—Ti—B alloys, Ga—Mg alloys, Ga—Zn alloys, Ga—Fe alloys, Ga—Li alloys (e.g., alloys of Ga and lithium (Li)), Ga—K alloys (e.g., alloys of Ga and potassium (K)), Ga—Ba alloys, Ga—Ca alloys, and Ga—Na alloys (e.g., alloys of Ga and sodium (Na)), with or without a combination of one or more other elements, such as In, Sn, Ti, B, C, Ag, Cu, Fe, silicon (Si), lead (Pb), Zn, Ni, chromium (Cr), bismuth (Bi), rare earth elements, etc. Also or alternatively, one or more zinc amalgams (HgZn) may be added to the one or more Ga-Alkali metal alloys. The one or more Ga-alkali metal alloys may comprise one or more of any of the Ga alloys identified in U.S. patent application Ser. No. 17/094,577, filed Nov. 10, 2020, and titled “Thermal Fuse,” which application in its entirety is incorporated by reference herein.

The one or more Ga-alkali metal alloys added in step 16 may be in liquid form, and/or may be in particulate form. If in particulate form, particles may have sizes in a range similar to the range of sizes indicated above for the dielectric material particles and for the bonding agent particles (e.g., from 20 nm to 2000 μm, with particle size between 100 nm and 100 μm preferred in at least some applications, and with minimum particle size as low as 4 nanometers or even lower). Also or alternatively, particles of Ga-alkali metal alloy(s) added in step 16 may be larger, as many such alloys will melt below their eutectic reaction temperature.

The uncured sinterable dielectric compound resulting from step 16 will be stable if kept below the eutectic reaction temperature of the Ga-alkali metal alloy(s) in the compound, and may be stored for long periods of time before use. As described in more detail below, that use may comprise forming the compound into a desired shape (e.g., on a substrate) and curing at relatively low temperature and pressure. The consistency of the uncured sinterable dielectric compound, which may range from a liquid to a paste, may be determined by selection of gel ingredients and/or by proportion of gel to other components of the compound. Thinner consistencies may be desirable for certain applications and/or article fabrication methods (e.g., forming smaller dielectric articles and/or using methods such as printing). Thicker consistencies may be desirable for other applications and/or fabrication methods (e.g., if the ability of the uncured compound to at least partially retain a formed shape without external support is helpful).

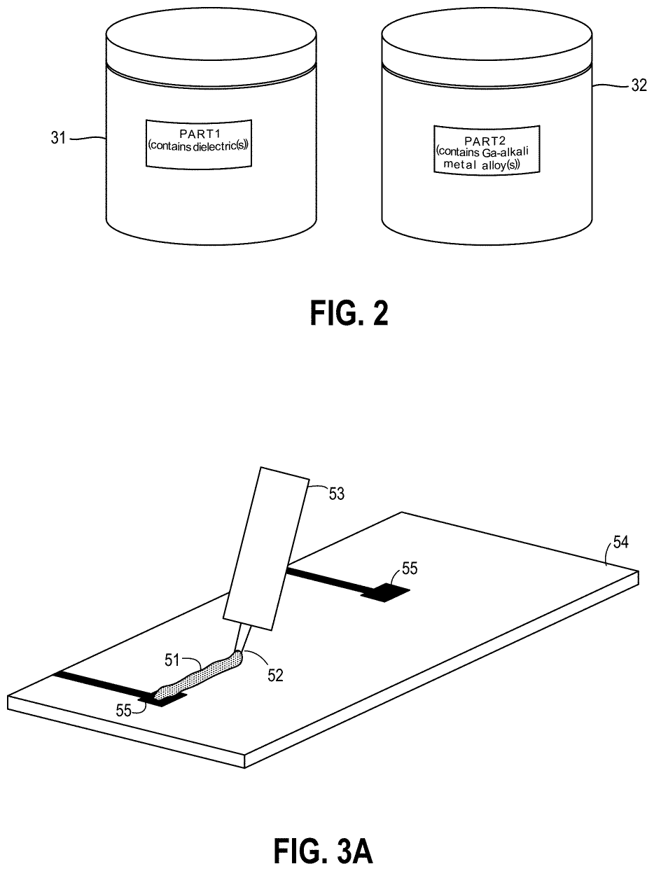

A uncured sinterable dielectric compound resulting from step 16 may be stored (e.g., in an air-tight container) as a ready-to-use compound. When needed, that uncured compound may be removed from the container, formed into a desired shape, and cured (e.g., as described below). Alternatively, steps 10-16 could be modified to prepare two (or more) parts of an uncured sinterable dielectric compound. When needed, those parts could be mixed and cured. For example, a first part may comprise a mixture of a gel, particles of one or more dielectric materials, and particles of one or more bonding agents. A second part may comprise one or more Ga-alkali metal alloys. As shown in FIG. 2, the first part could be stored in a first airtight container 31, and the second part could be stored in a second airtight container 32. Although jars are shown for simplicity in FIG. 2, any type of container (e.g., squeeze tube, bottle, drum, can, etc.) could be used. When needed, a quantity of first part and a quantity of the second part could be removed from the containers 31 and 32, mixed, formed into a shape (e.g., as described below), and cured (e.g., as described below). Step 16 may comprise mixing of the separately-stored/packaged parts.

Separately storing parts instead of a ready-to-use uncured sinterable dielectric compound may help prevent or reduce material waste or loss if a storage temperature inadvertently rises above the eutectic reaction temperature of the Ga-alkali metal alloy(s). If a separately-stored part comprising Ga-alkali metal alloy(s) comprises alloy(s) in particulate form, and if the temperature of that second part rises above the eutectic reaction temperature, particles of the Ga-alkali metal alloy(s) may melt and/or fuse. In such case, and if particulate form of the alloy(s) is needed, it may be appropriate to reprocess (e.g., regrind) that second part before use, but recovery of that material would still be simple and relatively inexpensive. Conversely, if a storage temperature of a ready-to-use uncured sinterable dielectric compound inadvertently exceeds the eutectic reaction temperature, some or all of the alkali metal element(s) of the Ga-alkali metal alloy(s) may be consumed as a result of unintended curing.

As indicted above, one or more of steps 12-16 may be omitted, combined, performed in an order other than shown in FIG. 14, and/or otherwise modified, and/or other steps may be added. For example, addition of a bonding additive may be omitted. As other examples, bonding additive particles could be mixed with a gel prior to mixing of the dielectric material particles, bonding additive particles and dielectric material particles could be mixed together before adding to the gel, etc. As a further example, steps could be added to package a mixture of the gel and dielectric material particles (and optionally, bonding additive particles) as the first part in the container 31 and to package Ga-alkali metal alloy(s) as the second part in the container 32, to mix those parts, etc.

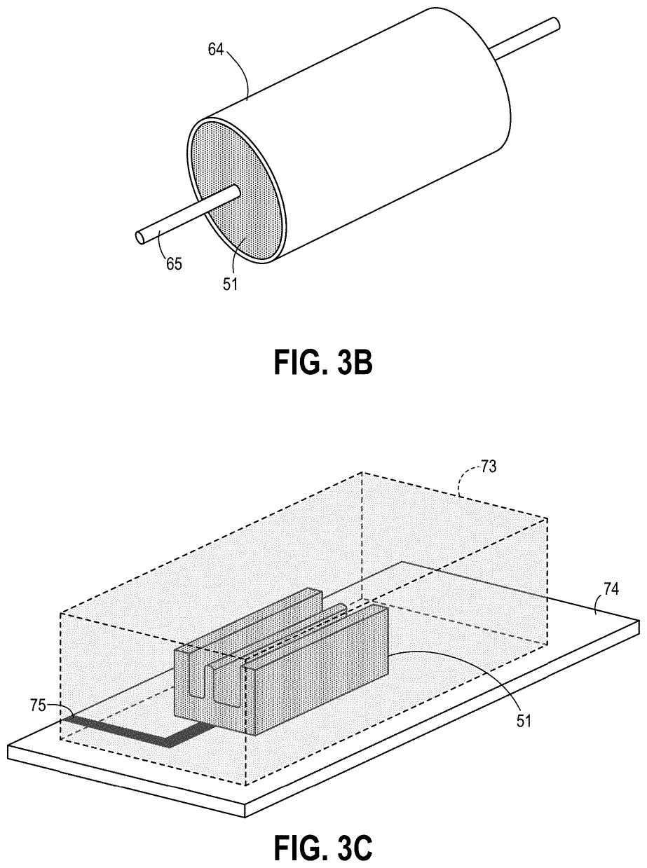

In step 18, the uncured sinterable dielectric compound of step 16, or a portion of that uncured compound, may be formed into a shape. The forming may comprise printing or patterning the uncured compound on a substrate. For example, and as shown in FIG. 3A, uncured sinterable dielectric compound 51 may be extruded from an outlet 52 of a syringe 53 (e.g., a print head) onto a substrate 54. The compound 51 may be extruded so as to contact or otherwise have a desired position relative to electrical contacts 55 and/or other structures on the substrate 54. As another example, and as shown in FIG. 3B, uncured sinterable dielectric compound 51 may be injected into, or otherwise used to fill, a cavity of a substrate 64. Another structure 65 (e.g., an electrode wire) may be inserted into the compound 51 before curing. As a further example, and as shown in FIG. 3C, uncured sinterable dielectric compound 51 may fill a cavity of a mold 73. Molding may be used, for example, to form dielectric articles having complex shapes and that may be impractical to manufacture using conventional methods of forming dielectric elements. A bottom side of the cavity may be open, thereby allowing the compound 51 to contact (and bond to during curing) a surface of a substrate 74 and/or an electrical contact 75 or other structure on the surface of the substrate 74.

A substrate (e.g., the substrates 54, 64, and/or 74) may, after curing of uncured sinterable dielectric compound placed thereon (e.g., the uncured compound 51) form a part of a completed dielectric article. A dielectric article may be an object that comprises one or more material regions (e.g., one or more blocks, sheets, slabs, strips, blobs, etc.) that comprise, consist essentially of, or consist of cured dielectric compound. The one or more material regions may be bonded to the substrate, which bonding may also occur during (and/or as a result of) the curing process. For example, a substrate may comprise a printed circuit board (PCB), and cured dielectric compound may comprise regions such as those shown (in part) in FIGS. 3A and 3C. However, a substrate need not have a planar shape. A substrate, uncured sinterable dielectric compound placed thereon, and cured dielectric compound may have any geometry. A substrate may comprise any material or combination of materials. Examples of substrate materials comprise metals and/or alloys (e.g., Cu, Al, stainless steel, etc.), polymers (e.g., polyethylene terephthalate (PET), polyethylene naphthalate (PEN), polycarbonate (PC), polyethersulfone (PES), polyimide (PI), polyarylate (PAR), polydimethylsiloxane (PDMS) (e.g., as a stretchable substrate), etc.), glasses, ceramics, papers, textiles, etc.

A substrate need not be part of a completed dielectric article. For example, uncured sinterable dielectric compound may formed into a shape on a substrate (e.g., a sheet of silicone-coated release paper) from which the formed compound is removed after curing.

In step 20, the temperature of the uncured sinterable dielectric compound formed into a shape in step 18 may be raised above the eutectic reaction temperature of the Ga-alkali metal alloy component(s) of that uncured compound. As indicated above, that eutectic reaction temperature may vary based on Ga-alkali metal alloys selected. For at least some applications, preferred eutectic reaction temperatures may be in a range of 30° C. (±5%) to 100° C. (±5%) (e.g., 26.8° C.±5%). After raising the temperature above the eutectic reaction temperature, alkali metal from the Ga-alkali metal alloy component(s) of the uncured compound begin to exothermically react with water in the compound, and self-sintering begins.

In step 22, the uncured sinterable dielectric compound formed into a shape in step 18 is allowed to cure. Step 22 may comprise maintaining a temperature of the formed shape above the eutectic reaction temperature for a cure period. The duration of the cure period may depend on the temperature. Step 22 may be performed at lower temperatures (e.g., 30° C. to 35° C., or above). At lower temperatures, the cure period may, for example, be 1-3 hours. The self-sintering reaction may be accelerated by raising the temperature. For example, at slightly higher temperatures (e.g., at or near 100° C.), a cure period for a thin layer (e.g., 1 mm to 3 mm thick) film of dielectric compound may be reduced to several minutes. In general, thinner regions will cure more quickly. Cure time may also be affected by components of the dielectric compound and/or concentrations of such components. For example, increasing the percentage of water in the uncured compound (e.g., by increasing the percentage of gel and/or the percentage of water in the gel) combined with increasing a percentage of Al (and/or other alkali metal) in the uncured compound (e.g., by increasing a percentage of Ga—Al alloy(s) and/or a percentage of Al in the Ga—Al alloy(s)) may accelerate cure time, but may reduce the ability of formed uncured compound to maintain a shape without external support.

Steps 20 and 22 (and indeed, all steps shown in FIG. 1) may be performed at atmospheric pressure (e.g., 0.1 MPa), at near atmospheric pressures (e.g., between 0.1 MPa and 1 MPa), or sub-atmospheric pressures (e.g., less the 0.1 MPa). Moreover, external pressure need not be applied to dielectric compound (e.g., by a piston, platen, or other mechanical means) during cure.

After step 22 the cured dielectric compound, and/or an article comprising the cured dielectric compound, may undergo additional processing. Such processing may, for example, comprise grinding/smoothing/machining of the cured dielectric compound and/or other parts, placement and curing of additional sinterable dielectric compound (e.g., to create layers having different dielectric or other properties), attaching additional elements, etc.

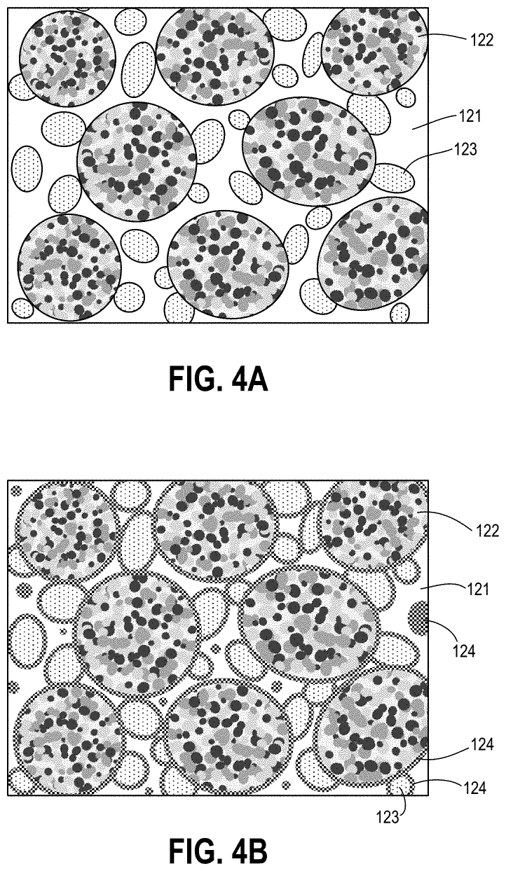

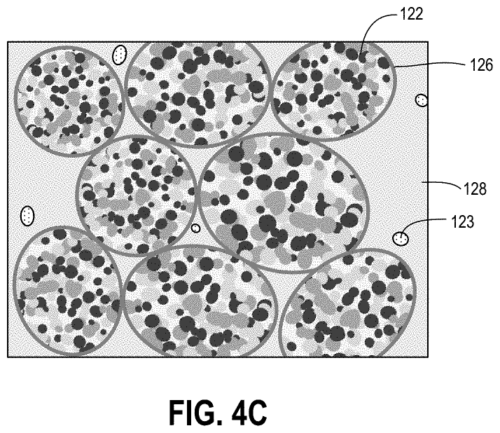

FIGS. 4A, 4B, and 4C are diagrams showing, at a particle level, example structures during forming of a sinterable dielectric compound and after curing. FIG. 4A shows a mixture of a gel 121, dielectric material particles 122 (indicted by multi-shade grain pattern), and bonding agent particles 123 (indicated by light stippling). The mixture of FIG. 4A may, for example, be a mixture resulting at the completion of step 14 of FIG. 1. FIG. 4B shows an uncured sinterable dielectric compound that comprises a mixture of the gel 121, the dielectric material particles 122, the bonding agent particles 123, and one of more Ga-alkali alloys 124 (indicated by bold stippling) that may adhere to surfaces of particles and/or be present as separate particles or droplets. The uncured compound of FIG. 4B may, for example, be a compound resulting at the completion of step 16 of FIG. 1. In FIG. 4B, the temperature of the compound has been maintained below a eutectic reaction temperature of the one of more Ga-alkali alloys 124. FIG. 4C shows the compound of FIG. 4B after curing. FIG. 4C may, for example, be a cured compound at the completion of step 22 of FIG. 1. During curing, exothermic reaction between the water and the alkali metal(s) from the Ga-alkali metal alloy(s) created intense but highly localized heating that affected surfaces 126 (shown as gray lines around dielectric material particles 122) of the dielectric material particles 122 (e.g., by melting, oxidation, and/or other process) and bonded the dielectric material particles 122 together where surfaces 126 contact. Moreover, Ga diffusion and/or intermetallic oxidation reactions at grain boundaries between the particles 122 and/or in voids between the particles 122 resulted in metallic oxides 128 that provide further densification, reduce porosity, and/or enhance adhesion/bonding between the particles 122. Small amounts of bonding agent particles 123 may remain. Water in the gel 121 is consumed or driven off during curing. Although not shown in FIG. 4C, small amounts of other components of the gel may remain after curing, but in quantities that do not affect desired dielectric and/or other properties of the cured compound.

Table 1 shows components and amount ranges for additional example formulations that may be used for various applications.

TABLE 1

| amount | component |
|---|---|
| 10 wt % to 80 wt % | water-soluble resin gel (3 wt % to |
| | 20 wt % of POLYX ™ WSR N750 |
| | (or other resin), remainder water) |
| 5 wt % to 30 wt % | Ga-alkali metal alloy (e.g., Ga-13.5 wt % |
| | Sn3Ag0.5Cu-1 wt % Al3Ti0.5C, Ga-(1-5) |
| | wt % Al, Ga-(1-3) wt % Mg, Ga-21.5 wt % |
| | ln-10 wt % Sn-2 wt % Al3Ti0.5C, Ga-(1-5) |
| | wt % Al3Ti0.5C) |
| 5 wt % to 15 wt % | micro-and/or nanoparticles of one or more |
| | metallic binders (e.g., Ag, Cu, Al, Ni/Ag |
| | powders) and/or particle free silver ink |
| 10 wt % to 90 wt % | one or more dielectric fillers (e.g., fumed |
| | silica, alumina, AIN, diamond, one or more |
| | ferrites, lead zirconate titanate (PZT); |
| | dielectric fillers may be in the form of |
| | micro-and/or nanoparticles |

In Table 1, an amount in a cell of the left column indicates a range of percentage, relative to the total of all components in the final compound, of the component(s) indicated in the corresponding cell of the right column. Percentages indicated in cells of the right column are relative other components in that cell. Ga-13.5 wt % Sn3Ag0.5Cu-1 wt % Al3Ti0.5C may comprise an alloy of: (i) 13.5 wt % of a Sn3Ag0.5Cu master alloy (e.g., an alloy comprising: 3 wt % Ag (of a total weight of Sn, Ag, and Cu in the master alloy), 0.5 wt % Cu (of a total weight of Sn, Ag, and Cu in the master alloy), and an amount of Sn that forms a balance wt % (of the total weight of Sn, Ag, and Cu in the master alloy)), (ii) 1 wt % of an Al3Ti0.5C master alloy (e.g., an alloy comprising: 3 wt % Ti (of a total weight of Al, Ti, and C in the master alloy), 0.5 wt % C (of a total weight of Al, Ti, and C in the master alloy), and an amount of Al that forms a balance wt % (of the total weight of Al, Ti, and C in the master alloy)), and (iii) an amount of Ga (e.g., 85.5 wt %) that forms a balance wt % of the Ga-13.5 wt % Sn3Ag0.5Cu-1 wt % Al3Ti0.5C alloy. Ga-(1-5) wt % Al may comprise an alloy of 1 wt % to 5 wt % Al and a balance (e.g., 95 wt % to 99 wt %) of Ga. Ga-(1-3) wt % Mg may comprise an of alloy 1 wt % to 3 wt % Mg and a balance (e.g., 97 wt % to 99 wt %) of Ga. Ga-21.5 wt % In-10 wt % Sn-2 wt % Al3Ti0.5C may comprise an alloy of: (i) 21.5 wt % In, (ii) 10 wt % Sn, (iii) 2 wt % of an Al3Ti0.5C master alloy, and (iv) a balance (e.g., 66.5 wt %) of Ga. Ga-(1-5) wt % Al3Ti0.5C may comprise an alloy of 1 wt % to 5 wt % of an Al3Ti0.5C master alloy a balance (e.g., 95 wt % to 99 wt %) of Ga.

When preparing a formulation based on the example ranges and components of Table 1, the POLYX™ WSR N750 powder (or other resin powder), dielectric filler material(s), and binder(s) (e.g., Ni/Ag binder powder) may be mixed with water to form a uniform gel mixture at room temperature. This uniform gel mixture may be mixed with liquid Ga-alkali metal alloy (e.g., Ga-2 wt % Al3Ti0.5C), at a controlled temperature between 15° C. and 20° C., to form a paste. The paste may be kept at a temperature of 20° C. or below until after the paste has been formed onto a substrate and curing is desired. This includes keeping the paste temperature 20° C. or below during loading into a syringe or other printing device and during application of the paste to a substrate. The substrate may also be kept at a temperature of 20° C. of lower during paste application, and until cure of applied paste is desired.

As indicated above, desired properties of a dielectric article can be tuned by selection of dielectric materials for a sinterable dielectric compound. For example, electrical resistance of a dielectric article can be tuned from high impedance conductors/ferrites, to semiconducting, to insulating. As another example, dielectric materials can be selected to achieve high thermal conductivity. Thermal conductivities of 170 Watt/meter·° K (W/mK) to 200 W/mK are expected for dielectric articles formed from compounds with AlN-based dielectric materials. Thermal conductivities of 600 W/mK to 1,500 W/mK are expected for dielectric articles formed from compounds with diamond-based dielectric materials. Dielectric articles form from compounds reinforced with nano-size fumed silica have exhibited excellent flexibility and high shear strength and bonding strength with metals like copper (≥60 pounds (lbs) for 1 square centimeter (cm²) Cu—Cu joint). Nano-sized dielectric fillers may be used enhance strength and ductility/flexibility of a dielectric article produced from compounds that include such fillers.

Sinterable dielectric compounds may be molded/patterned/printed or otherwise formed into a desired shape and self-sintered at or near room temperatures. Ga-based low melting alloys may supercool far below their melting point, thereby making it possible to process and apply a sinterable dielectric compound paste or ink at much lower temperatures, and may cure (e.g., self-sinter) via an ultralow energy-consuming process mechanized by exothermic alkali metal and water reaction. Dielectrics articles may be formed, using sinterable dielectric compounds, for numerous different applications and/or functions. Examples of such applications and/or functions may include, without limitation, high thermal conductivity elements, elements with ferromagnetic function, elements having piezoelectric and/or thermoelectric function, elements with high frequency performance, PCBs, flexible/wearable electronics, bioelectronics (e.g., implants), batteries, capacitors and/or supercapacitors, heat spreaders, insulators, semiconductors, capacitors, thermal spreaders, filters, antennas, ferroelectric memory, thermoelectric generators, medical transducers, 2.5D/3D electronic system-on-a-chip, multi-step electronics packaging, resonators, electrolytes, cathodes, piezoelectric sensors, thermoelectric materials, heat shields, hypersonic vehicle fuselage components, microwave and mm-wave substrates, printed electronics (rigid or flexible), anti-tamper electronics, high-density packaging, radio frequency passive components, optoelectronic devices, and other applications and/or functions. Sinterable dielectric compounds such as those described herein may be useful in technologies in which one or more mechanical, electrical, chemical, and/or other type of physical elements cannot withstand extreme temperatures or pressures, but in which dielectric elements conventionally formed at higher temperatures or pressures are needed or useful.

Amalgams of mercury (Hg) and one or more alkali metals may be used instead of (or in combination with) Ga-alkali metal alloys to form an uncured sinterable dielectric compound, and such uncured compounds may be used in ways similar to the above-described uses of uncured sinterable dielectric compounds. For example, some or all of the Ga-alkali metal alloy(s) described in connection with uncured compounds above may be replaced with an amalgam of Hg and one or more alkali metals. The quantity of the replacement Hg amalgam may be an amount (e.g., a wt % of the compound being formed) that would provide the same (or similar) amount of alkali metal that would have been provided by the amount of Ga-alkali metal alloy(s) being replaced. The compound may be formed in a manner similar to those described above, although temperatures during mixing, during handling after mixing, and/or during storage may be adjusted based on the eutectic reaction temperature of the Hg amalgam(s) used to form the uncured compound. Similarly, when forming a dielectric article using an uncured sinterable dielectric compound comprising an Hg amalgam, the temperature below which a substrate should be maintained before compound cure, and the temperature at which the compound may be cured, may be adjusted based on the Hg amalgam used. If cure temperatures are adjusted based on Hg amalgam(s) in the compound, cure times for a compound comprising Hg amalgam(s) are expected to be similar to cure times described above. Examples of Hg amalgams that may be used to replace some or all of Ga-alkali metal alloy(s) in a sinterable dielectric compound may comprise one or more amalgams that comprise, consist essentially of, or consist of 99 wt % to 50 wt % of Hg, with the remainder being an alkali metal and, optionally, one or more additional elements. Examples of such Hg-alkali metal amalgams comprise Hg—Al amalgams, Hg—AlTiC amalgams, Hg—Al—Ti—B amalgams, Hg—Mg amalgams, Hg—Zn amalgams, Hg—Fe amalgams, Hg—Li amalgams, Hg—K amalgams, Hg—Ba amalgams, Hg—Ca amalgams, and Hg—Na amalgams, with or without a combination of one or more other elements, such as In, Sn, Ti, B, C, Ag, Cu, Fe, Si, Pb, Zn, Ni, Cr, Bi, rare earth elements, etc. Examples of eutectic reaction temperatures for Hg amalgams comprise −41° C. for Hg—Mg to approximately 400° C. for Hg—Fe. Although use of some Hg amalgams may be toxic and/or may result in a dielectric article that comprises toxic elements, use of Hg amalgams may be advantageous under some conditions. For example, the processing temperature range is broader than Ga-alkali metal alloys, especially for low temperature processing during assembly. Additionally, Hg-alkali metal amalgams may be more beneficial or suitable for filling porosity, cracks, and/or voids in self-sintered dielectrics. This may promote possible self-healing characteristics, as Hg possesses a high density and forms amalgams with almost all kinds of metals.

For the avoidance of doubt, the present application includes, but is not limited to, the subject-matter described in the following numbered clauses:
1. A compound comprising: particles of one or more filler materials; one or more Ga-alkali metal alloys and/or one or more Hg-alkali metal amalgams; and a water-soluble gel.
2. The compound of clause 1, wherein the particles of one or more filler materials comprise particles of one or more dielectric filler materials.
3. The compound of clause 2, wherein the particles of the one or more dielectric filler materials, the one or more gallium-alkali metal alloys and/or one or more Hg-alkali metal amalgams, and water-soluble polymer gel form an uncured sinterable dielectric mixture.
4. The compound of any of clauses 1-3, wherein the compound comprises at 10 wt % of the particles of one or more filler materials, at least 5 wt % of the one or more Ga-alkali metal alloys and/or one or more Hg-alkali metal amalgams; and at least 10 wt % of the water-soluble gel.
5. The compound of any of clauses 1-4, wherein the water-soluble gel comprises a water-soluble polymer gel.
6. The compound of any of clauses 1-5, wherein the one or more Ga-alkali metal alloys comprise one or more of: one or more Ga—Al alloys; one or more Ga—AlTiC alloys; one or more Ga—Al—Ti—B alloys; one or more Ga—Mg alloys; one or more Ga—Zn alloys; one or more Ga—Fe alloys; one or more Ga—Li alloys; one or more Ga—K alloys; one or more Ga—Ba alloys; one or more Ga—Ca alloys; or one or more Ga—Na alloys.
7. The compound of clause 6, wherein the one or more Ga-alkali metal alloys further comprise one or more of In, Sn, Ti, B, C, Ag, Cu, Fe, Si, Pb, Zn, Ni, Cr, Bi, or one or more rare earth elements.
8. The compound of clause 6 or clause 7, wherein the one or more Ga-alkali metal alloys comprise one or more of: Ga-13.5 wt % Sn3Ag0.5Cu-1 wt % Al3Ti0.5C; Ga-(1-5) wt % Al; Ga-(1-3) wt % Mg; Ga-21.5 wt % In-10 wt % Sn-2 wt % Al3Ti0.5C; or Ga-(1-5) wt % Al3Ti0.5C.
9. The compound of any of clauses 1-8, wherein the one or more Hg-alkali metal amalgams comprise one or more of: one or more Hg—Al amalgams: one or more Hg—AlTiC amalgams; one or more Hg—Al—Ti—B amalgams; one or more Hg—Mg amalgams; one or more Hg—Zn amalgams; one or more Hg—Fe amalgams; one or more Hg—Li amalgams; one or more Hg—K amalgams; one or more Hg—Ba amalgams; one or more Hg—Ca amalgams; or one or more Hg—Na amalgams.
10. The compound of clause 9, wherein the one or more Hg-alkali metal amalgams further comprise one or more of In, Sn, Ti, B, C, Ag, Cu, Fe, Si, Pb, Zn, Ni, Cr, Bi, or one or more rare earth elements.
11. The compound of any of clauses 1-10, further comprising particles of one or more bonding agents.
12. The compound of clause 11, wherein the compound comprises at least 5 wt % of the particles of the one or more bonding agents.
13. The compound of clause 11 or clause 12, wherein the one or more bonding agents comprise one or more of: a metal, a metal alloy, or a metallic oxide.
14. The compound of any of clauses 11-13, wherein the one or more bonding agents comprise one or more of: Ag; an Ag alloy; Au, an Au alloy; Cu; a Cu alloy; Zn; a Zn alloy; Ni; or an Ni alloy.
15. The compound of any of clauses 1-14, wherein the compound consists essentially of: the particles of one or more filler materials; the one or more Ga-alkali metal alloys and/or one or more Hg-alkali metal amalgams; the water-soluble gel; and the particles of one or more bonding agents.
16. The compound of any of clauses 1-15, wherein the particles of one or more filler materials are particles having a size range between 20 nanometers and 2000 micrometers.
17. The compound of any of clauses 1-16, wherein the particles of one or more filler materials comprise particles of one or more of: silica; alumina; one or more nitrides; one or more perovskites; one or more oxides of one or more group IIA, group IIIA, group IIIB, group IVB or group VB metals; AlN; Al₂O₃; BeO; SiC; Si; PZT; diamond; one or more ferrites; one or more piezoelectric ceramics; one or more thermoelectric ceramics; one or more microwave or millimeter-wave ceramics; or one or more optical materials.
18. The compound of any of clauses 1-17, wherein the one or more Ga-alkali metal alloys and/or one or more Hg-alkali metal amalgams comprise one or more Ga-alkali metal alloys and/or one or more Hg-alkali metal amalgams having a eutectic reaction temperature of 30° C. or less.
19. The compound of any of clauses 1-18, wherein the water-soluble gel comprises a mixture of a nonionic polymer and water.
20. A method comprising creating the compound of any of clauses 1-19.
21. The method of clause 20, wherein the creating comprises mixing components of the compound.
22. A method comprising: raising a temperature of the compound, of any of clauses 1-21, above a eutectic reaction temperature of the one or more Ga-alkali metal alloys and/or Hg-alkali metal amalgams of the compound; and allowing the compound to self-sinter by maintaining, until cured, the compound at one or more temperatures above the eutectic reaction temperature.
23. The method of clause 22, wherein the allowing the compound to self-sinter comprises maintaining, until cured, the compound at a temperature between 30° C. and 100° C.
24. The method of clause 22 or clause 23, wherein the allowing the compound to self-sinter comprises maintaining, until cured, the compound at a pressure of 1 megapascal or less.
25. The method of any of clauses 22-24, further comprising: prior to the raising a temperature of the compound above the eutectic reaction temperature, forming the compound into a shape by one or more of: molding the compound; or applying the compound to a substrate.
26. The method of any of clauses 21-25, wherein the mixing comprises mixing components of the compound a temperature below 20° C., the method further comprising: maintaining, prior to the raising the temperature, the compound at a temperature below 20° C.
27. A dielectric article fabricated by the method of any of clauses 20-26.

The foregoing has been presented for purposes of example. The foregoing is not intended to be exhaustive or to limit features to the precise form disclosed. The examples discussed herein were chosen and described in order to explain principles and the nature of various examples and their practical application to enable one skilled in the art to use these and other implementations with various modifications as are suited to the particular use contemplated. The scope of this disclosure encompasses, but is not limited to, any and all combinations, subcombinations, and permutations of structure, operations, and/or other features described herein and in the accompanying drawing figures.

1. A compound comprising:
at least 10%, by weight, particles of one or more dielectric filler materials;
at least 5%, by weight, one or more gallium-alkali metal alloys; and
at least 10%, by weight, water-soluble polymer gel,
wherein the particles of the one or more dielectric filler materials, the one or more gallium-alkali metal alloys, and the water-soluble polymer gel form an uncured sinterable dielectric mixture.

2. The compound of claim 1, further comprising at least 5%, by weight, particles of one or more bonding agents comprising one or more of: a metal, a metal alloy, or a metallic oxide.

3. The compound of claim 2, wherein the one or more bonding agents comprise one or more of: silver, a silver alloy, gold, a gold alloy, copper, a copper alloy, zinc, a zinc alloy, nickel, or a nickel alloy.

4. The compound of claim 2, wherein the compound consists essentially of the particles of the one or more dielectric filler materials, the one or more gallium-alkali metal alloys, the water-soluble polymer gel, and the particles of the one or more bonding agents.

5. The compound of claim 1, wherein the particles of the one or more dielectric filler materials comprise particles, having a size range between 20 nanometers and 2000 micrometers, of one or more of: silica; alumina; one or more nitrides; one or more perovskites; one or more oxides of one or more group IIA, group IIIA, group IIIB, group IVB or group VB metals; aluminum nitride (AlN); aluminum oxide (Al₂O₃); beryllium oxide (BeO); silicon carbide (SiC); silicon; lead zirconate titanate (PZT); diamond; one or more ferrites; one or more piezoelectric ceramics; one or more thermoelectric ceramics; one or more microwave or millimeter-wave ceramics; or one or more optical materials.

6. The compound of claim 1, wherein the one or more gallium-alkali metal alloys comprise one or more of: an alloy of gallium and aluminum, an alloy of gallium and magnesium, an alloy of gallium and zinc, an alloy of gallium and iron, and alloy of gallium and lithium, an alloy of gallium and potassium, an alloy of gallium and barium, an alloy of gallium and calcium, or an alloy of gallium and sodium.

7. The compound of claim 1, wherein the one or more gallium-alkali metal alloys have a eutectic reaction temperature of 30° C. or less.

8. The compound of claim 1, wherein the water-soluble polymer gel comprises a mixture of a nonionic polymer and water.

9. The compound of claim 1, wherein:
the one or more gallium-alkali metal alloys comprise one or more alloys of gallium and aluminum, and
the compound consists essentially of: the particles of the one or more dielectric filler materials; the one or more alloys of gallium and aluminum; the water-soluble polymer gel; and one or more bonding agents.

10. A method comprising:
creating an uncured sinterable dielectric compound comprising:
particles of one or more dielectric filler materials;
one or more gallium-alkali metal alloys; and
a water-soluble polymer gel;
raising a temperature of the compound above a eutectic reaction temperature of the one or more gallium-alkali metal alloys; and
allowing the compound to self-sinter by maintaining, until cured, the compound at one or more temperatures above the eutectic reaction temperature.

11. The method of claim 10, wherein the allowing the compound to self-sinter comprises maintaining, until cured, the compound at a temperature between 30° C. and 100° C.

12. The method of claim 11, wherein the allowing the compound to self-sinter comprises maintaining, until cured, the compound at a pressure of 1 megapascal or less.

13. The method of claim 10, further comprising:
prior to the raising a temperature of the compound above the eutectic reaction temperature, forming the compound into a shape by one or more of:
molding the compound; or
applying the compound to a substrate.

14. The method of claim 10, wherein the creating further comprises creating the compound to comprise particles of one or more bonding agents comprising one or more of: a metal, a metal alloy, or a metallic oxide.

15. The method of claim 14, wherein the one or more bonding agents comprise one or more of: silver, a silver alloy, gold, a gold alloy, copper, a copper alloy, zinc, a zinc alloy, nickel, or a nickel alloy.

16. The method of claim 10, wherein the compound consists essentially of the particles of the one or more dielectric filler materials, the one or more gallium-alkali metal alloys, the water-soluble polymer gel, and particles of one or more bonding agents.

17. The method of claim 10, wherein the particles of the one or more dielectric filler materials comprise particles, having a size range between 20 nanometers and 2000 micrometers, of one or more of: silica; alumina; one or more nitrides; one or more perovskites; one or more oxides of one or more group IIA, group IIIA, group IIIB, group IVB or group VB metals; aluminum nitride (AlN); aluminum oxide (Al₂O₃); beryllium oxide (BeO); silicon carbide (SiC); silicon; lead zirconate titanate (PZT); diamond; one or more ferrites; one or more piezoelectric ceramics; one or more thermoelectric ceramics; one or more microwave or millimeter-wave ceramics; or one or more optical materials.

18. The method of claim 10, wherein the one or more gallium-alkali metal alloys comprise one or more of: an alloy of gallium and aluminum, an alloy of gallium and magnesium, an alloy of gallium and zinc, an alloy of gallium and iron, an alloy of gallium and lithium, an alloy of gallium and potassium, an alloy of gallium and barium, an alloy of gallium and calcium, or an alloy of gallium and sodium.

19. The method of claim 10, wherein the creating comprises mixing the particles of the one or more dielectric filler materials, the one or more gallium-alkali metal alloys, and the water-soluble polymer gel at a temperature below 20° C., the method further comprising:
maintaining, prior to the raising the temperature, the compound at a temperature below 20° C.

20. A dielectric article fabricated by the method of claim 10.
